(19) United States
(12) Patent Application Publication
(10) Pub. No.: US 2015/0200440 A1
(43) Pub. Date: Jul. 16, 2015

(54) INDIVIDUALIZED SATELLITE TRANSMISSION SYSTEMS AND REMOTE VIEWING SYSTEMS

(71) Applicant: Alki Andrew David, Beverly Hills, CA (US)

(72) Inventor: Alki Andrew David, Beverly Hills, CA (US)

(21) Appl. No.: 14/597,338

(22) Filed: Jan. 15, 2015

Related U.S. Application Data
(60) Provisional application No. 61/927,604, filed on Jan. 15, 2014.
(60) Provisional application No. 61/932,960, filed on Jan. 29, 2014.

(51) Int. Cl. H01Q 1/12; H04H 20/74; H04H 40/90; H04N 21/61; H04N 5/44; H04N 7/20

(52) U.S. Cl. CPC H01Q 1/125; H04N 5/4401; H04N 7/20; H04H 40/90; H04N 21/6143; H04H 20/74

(57) ABSTRACT

Satellite transmission systems and remove viewing systems are provided. A system includes a satellite antenna, one or more processors communicatively coupled to the satellite antenna, one or more memory modules communicatively coupled to the one or more processors, and machine readable instructions stored in the one or more memory modules. The machine readable instructions, when executed by the one or more processors, cause the system to receive a request for selected data content, automatically determine an azimuth and elevation of the satellite antenna to optimize a signal-to-noise ratio to receive a signal comprising the selected data content from a satellite in response to receiving the request for the selected data content, and steer the satellite antenna to the azimuth and elevation such that the satellite antenna receives the signal comprising the selected data content from the satellite after determining the azimuth and elevation.

### CLAIM OF PRIORITY

This application claims the benefit of U.S. Provisional Application No. 61/927,604, entitled “Individualized Satellite Transmission System,” filed Jan. 15, 2014, the entirety of which is hereby incorporated by reference. This application claims the benefit of U.S. Provisional Application No. 61/932,960, entitled “Remote Viewing System,” filed Jan. 29, 2014, the entirety of which is hereby incorporated by reference.

### TECHNICAL FIELD

The present application relates to satellite feed data collection and distribution and remote viewing of broadcast television programs.

### BACKGROUND

Satellite television is television programming delivered by communications satellite(s) and received by an outdoor antenna(s), usually a flat planar array, or a parabolic reflector generally referred to as a satellite dish, and as far as household usage is concerned, a satellite receiver either in the form of an external set-top box or a satellite tuner module built into a TV set. Satellite TV tuners are also available as a card or a USB peripheral to be attached to a personal computer.

Satellite television, like other communications relayed by satellite, starts with a transmitting antenna located at an uplink facility. Uplink satellite dishes are very large, as much as 9 to 12 meters (30 to 40 feet) in diameter. The uplink dish is pointed toward a specific satellite and the uplinked signals are transmitted within a specific frequency range, so as to be received by one of the transponders tuned to that frequency range aboard that satellite. The transponder ‘retransmits’ the signals back to Earth but at a different frequency band. The leg of the signal path from the satellite to the receiving Earth station is called the downlink.

The downlinked satellite signal, quite weak after traveling the great distance (see inverse square law), can be collected by using a flat planar array, or a parabolic receiving dish, which reflects the weak signal to the dish's focal point. The signal may be further amplified by a low-noise block downconverter or LNB.

In many areas of the world, satellite television provides a wide range of channels and services, often to areas that are not serviced by terrestrial or cable providers. Direct-broadcast satellite television comes to the general public in two distinct flavors—analog and digital. Previously this has necessitated either having an analog satellite receiver or a digital satellite receiver. Consumers desire mechanisms to perform an online selection of audiovisual data, download such data, and view when, where, and on which device they choose.

### SUMMARY

In one embodiment, a system includes a satellite antenna, one or more processors communicatively coupled to the satellite antenna, one or more memory modules communicatively coupled to the one or more processors, and machine readable instructions stored in the one or more memory modules. The machine readable instructions, when executed by the one or more processors, cause the system to receive a request for selected data content, automatically determine an azimuth and elevation of the satellite antenna to optimize a signal-to-noise ratio to receive a signal comprising the selected data content from a satellite in response to receiving the request for the selected data content, and steer the satellite antenna to the azimuth and elevation such that the satellite antenna receives the signal comprising the selected data content from the satellite after determining the azimuth and elevation.

In another embodiment, a system includes a satellite antenna that outputs a downlink signal, a tv management server, an antenna controller, an integrated receiver/decoder farm, a media encoder, a streaming server, and a data storage system. The tv management server presents the user with a list of available data content accessible via the satellite antenna, and receives a request for selected data content in response to a user selection of an item of the list. In response to receiving the request for the selected data content, the antenna controller automatically determines an azimuth and elevation of the satellite antenna to optimize a signal-to-noise ratio to receive the downlink signal from the satellite, and, after determining the azimuth and elevation, steers the satellite antenna to the azimuth and elevation such that the satellite antenna receives the downlink signal. The integrated receiver/decoder farm receives the downlink signal from the satellite antenna, decodes the downlink signal, and outputs a media transport stream. The media encoder receives the media transport stream and encodes or transcodes the media transport stream into processed data. The streaming server transmits the processed data to a remote user computing device via the Internet. The data storage system is communicatively coupled to the satellite antenna and receives the selected data content and stores the selected data content.

In yet another embodiment, a system includes a satellite antenna that outputs a downlink signal, a tv management server, an antenna controller, a multiswitch, an integrated receiver/decoder farm, a media encoder, a streaming server, and a data storage system. The tv management server presents the user with a list of available data content accessible via the satellite antenna, and receives a request for selected data content in response to a user selection of an item of the list. In response to receiving the request for the selected data content, the antenna controller automatically determines an azimuth and elevation to optimize a signal-to-noise ratio to receive the downlink signal from a satellite, and, after determining the azimuth and elevation, steers the satellite antenna to the azimuth and elevation such that the satellite antenna receives the downlink signal from the satellite. The multiswitch receives the downlink signal and separates the downlink signal into a plurality of output signals. The integrated receiver/decoder farm that receives the output signals from the multiswitch, decodes the output signals from the multiswitch, and outputs a media transport stream. The media encoder receives the media transport stream and encodes or transcodes the data into processed data. The streaming server transmits the processed data to a remote user computing device via the Internet. The data storage system is communicatively coupled to the satellite antenna and receives the selected data content and stores the selected data content.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts an example architecture for a satellite transmission collection and distribution system, according to one or more embodiments shown and described herein;

FIG. 2 depicts an example of a board with a 10-channel transcoder used to encode a satellite transmission to a unique subscriber, according to one or more embodiments shown and described herein;

FIG. 3 depicts an exemplary block diagram of an 8-channel RF-Input to PCIe-Output board, according to one or more embodiments shown and described herein;

FIG. 4 depicts an example 7-8 inch flat-plate satellite downlink receiving antenna, according to one or more embodiments shown and described herein;

FIG. 5 depicts an example schematic of ATSC/QAM demodulator, according to one or more embodiments shown and described herein;

FIG. 6 depicts an example schematic of ATSC/QAM Tuner, according to one or more embodiments shown and described herein;

FIG. 7 depicts an example schematic of a PCIe Clock-Buffer, according to one or more embodiments shown and described herein;

FIG. 8 provides a hardware example of PC plug-in PCIe module, according to one or more embodiments shown and described herein;

FIG. 9 depicts an example architecture for a remote television viewing system, according to one or more embodiments shown and described herein;

FIG. 10 depicts a top-level block diagram of desktop viewer, according to one or more embodiments shown and described herein;

FIG. 11 depicts an example hardware circuit board, according to one or more embodiments shown and described herein; and

FIGS. 12-16 are exemplary screen shots of a possible sequence for remote viewing, according to one or more embodiments shown and described herein.

### DETAILED DESCRIPTION

The drawings, systems and methods described herein relate to the collection of satellite transmission feeds and the distribution of subsequently uniquely encoded streams of data to individual subscribers.

The present method and system relate to an approach to enable users to separately access individual satellite antennas, feeds, receivers and data storage systems, over a network connection, such as the Internet and/or service provider. Each user is assigned a separate satellite antenna, receiver, and collection and storage system. The individual user can stream live data content to their viewing system, upload the user's own data content, or store content for later viewing. As the individual users' select specific data content, their individual satellite antenna may be steered to the appropriate azimuth and elevation to optimize signal-to-noise ratio for data reception. In this way, individual users can have access to satellite transmissions without having to acquire and maintain their own satellite antenna infrastructure. Additionally, the present method and system provides access to satellite transmissions via the Internet or mobile devices without the necessity of acquiring the tuners, decoders, encoders, and transcoders required to directly access satellite transmissions.

The satellite antenna assignment is either permanent or temporary, depending on the specific contractual arrangement and the mode of operation. In one mode of operation, users have permanent and exclusive access to individual satellite antennas for the duration of the contract. In other modes, an individual antenna and collection system will be assigned to an individual user in response to a user request. After collection and subsequent streaming or recording of the data content to fulfill the request, the antenna resources are made available for other users.

According to one aspect of the method and system, individual users are presented with a list of available data content from satellite antenna collection. The system receives requests from the user, configures the system for reception, collection, streaming and recording, and provides the data to user devices.

In some embodiments, an application programming interface (API) is provided to enable users to design a “custom label” that provides the choice and selection of all the television and radio channels available. The API and custom label allow access, editing, updating, and content control though all device applications, such as, Android, Windows, Blackberry, Mac, PC, and iOS.

In some embodiments, deployment is available to all mobile applications, such as, iPhones, iPads, Android devices, and PDAs, etc. (subject to compliance with copyright and legal content provisions).

In some embodiments, the satellite antennas are steered and tuned to receive selected content from data providers. The data content is then demodulated, encoded, and/or transcoded, to appropriate resolutions or data formats, such as, for example, MPEG encoding.

Typically, the transcoded data is streamed to the user with a resolution based on the resolution required by the user device.

In an embodiment, the selected data are stored in a file prior to streaming to the user.

In another embodiment, user data is uploaded by the user. The user data may be streamed to other users or stored in a file. The stored user data may be kept private or may be made available for other users' access.

In one embodiment, the satellite antenna is optimized to receive specific data content, which is then available to a single, or multiple users.

In one mode, users are assigned satellite antennas temporarily, as required to satisfy specific data content requests. In another mode, users are assigned a dedicated satellite collection system or systems, as required by the terms of the contract.

In general, according to another aspect, the method and system features a system for streaming content transmissions to user devices. The system includes an application server presenting users with a list of available content, wherein the application server receives requests from the user devices to receive selected content from among the available content. The system further includes an antenna controller that controls satellite antennas to receive the selected content for each individual user, and a streaming server that streams the selected content as data in the appropriate format to the individual user devices.

In general, according to another aspect, the invention features a system for capturing satellite broadcasts. The system includes an array or “farm” of satellite receiving antennas, for receiving satellite content transmissions. The system further includes an application server that receives user requests for content transmissions from the available content, and an antenna controller that assigns individual antennas to each of the individual users based on the content transmissions requested by the users.

In general, according to another aspect, the method and system features a system for streaming content transmissions to user devices. The system comprises an application server presenting users with a list of available content, wherein the application server receives requests from the user devices to receive selected content among the available content. An antenna controller controls satellite antennas to receive the selected content transmissions for each individual user and assigns satellite antenna that are idle to receive content transmissions that the system anticipates users will want to watch in the future. Finally, a streaming server streams the selected content transmissions as content data to the user devices, and when a user desires to watch one of the anticipated content transmissions, the content data that are generated by the satellite antenna are allocated to the individual user and streamed to that user.

Embodiments disclosed herein enable users to remotely view digital media playing at a different location than the user's location. Users operate a display to view media played on a device, over a network connection, such as the Internet and/or service provider. Traditional simple screen-sharing does not provide the capability necessary to handle the requirements for rich media that can be played back in a resolution and speed acceptable to a consumer. Embodiments disclosed herein may utilize a dual core processor in the remote device to facilitate the necessary size and speed for acceptable playback of data streams.

According to one aspect of the method and system, two devices, one local and one remote, are communicatively coupled via a network such as the Internet. A first device is specially configured with hardware and/or software required to receive and tune over-the-air signals and/or incoming streams of media data, transcode the signals and/or data, and run said streams through a second remote device comprising hardware and/or software necessary for running audiovisual media. The audiovideo media may be viewed through a local display, which possesses the hardware and/or software required to display a shared desktop session/connection. Therefore, rather than re-transmitting the data stream stored or accessed on the remote device, the user may watch an image of a media playback on the remote device. This allows local players access to media at a wide variety of locations and/or channels.

According to one aspect of the method and system, individual users are presented with a list of available data content. The user may also be presented with a list of channels accessible via the system. The user selects a program or channel for viewing, and the local device connects to the remote device to view the selected content that is actually running on the remote device.

In some embodiments, a remote player may receive its data stream through a satellite farm, such as described in the Provisional Patent Application 61/927,604, which is included herein by reference. The remote player may also receive TV broadcasts through an antenna farm, a DVR farm, the Internet, or other storage mediums.

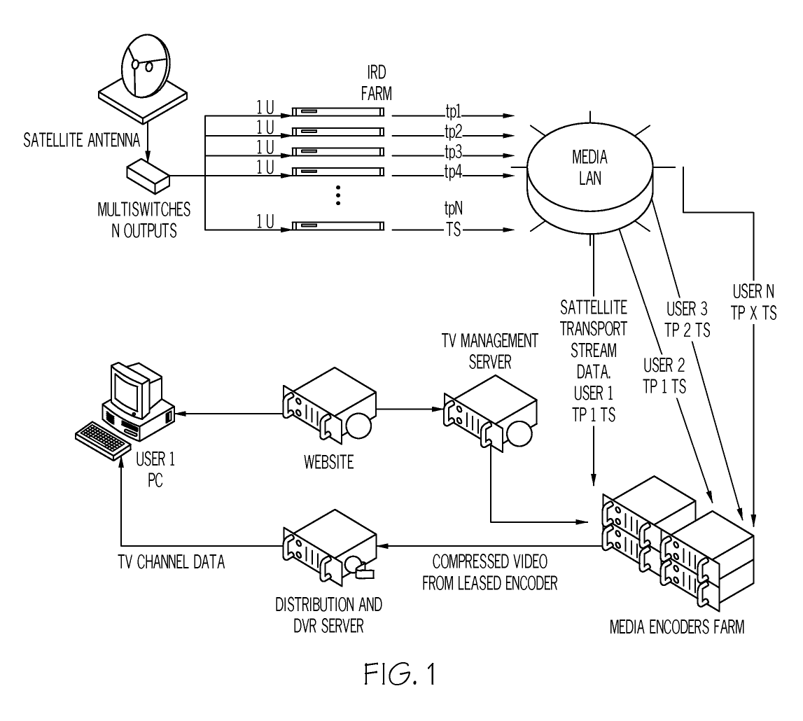

FIG. 1 shows a system 100 that enables individual users to receive satellite data content from antennas via a packet network such as the Internet, which has been constructed according to the principles of the present system. The system allows each user to separately access a satellite feed from an individually-assigned antenna for recording or live streaming.

In a typical implementation, users access the system 100 via the Internet with client devices. In the example shown in FIG. 1, the client device is a personal computer “User 1 PC” that accesses the system 100 via a website. The video content is displayed on the personal computer using HTML-5 or a program such as QuickTime by Apple Corporation. In other examples, the system 100 is accessed by mobile devices such as a tablet, e.g., iPad, mobile computing device, mobile phone, e.g., iPhone, computing device or mobile computing devices running the Android operating system by Google Inc. In other embodiments, a user may access a VPN (virtual private network) via a JAVA applet (e.g., Juniper Networks Junos® Pulse —http://www.juniper.net/us/en/local/pdf/datasheets/1000220-en.pdf) on an IP-connected device to access the system. HTML-5 is also used in some implementations to provide the video. Other examples are televisions that have network interfaces and browsing capabilities.

A TV management server manages the requests or commands from the client devices. It allows the users at the client devices to select whether they want to watch or access previously recorded content, i.e., a television program, set up a future recording of a broadcast of a television program, or to watch a live broadcast television program. In some examples, the system 100 also enables users to access and/or record radio (audio-only) broadcasts.

If the users request to set up future recordings or watch a live broadcast of satellite television programs, the TV management server communicates with a satellite antenna optimization and control system to configure resources to capture and record the desired satellite content by reserving antenna and encoding resources for the time and date of the future recording. On the other hand, if the users request to watch a live broadcast, then the TV management server and satellite antenna optimization and control system locate available antenna resources ready for immediate use. The satellite antenna optimization and control system maintains the assignment of this antenna to the user throughout any scheduled television program or continuous usage until such time as the user releases the antenna by closing the session, or by the expiration of a predetermined time period as maintained by a timer implemented in the control system. An alternative implementation would have each antenna assigned to a particular user for the user's sole usage.

The efficacy of the system is especially apparent when multiple users wish to view the same data content, either live or delayed. The system may only require a single satellite antenna, tuner, and collection system to acquire data for subsequent access by multiple users. Additionally, when multiple users request to store and view previously recorded content, the system may only require a single data file to be preserved.

After locating an optimized antenna element, the satellite antenna optimization and control unit allocates the satellite antenna to the user. The antenna optimization and control unit then signals the corresponding RF tuner to tune the allocated antenna to receive the broadcast.

Each orbiting satellite may downlink a number of possibly independent signals to the ground. The terrestrial satellite antenna receives the wideband downlink signal and filters and separates it into the many components signals using multiswitches and transponders at the integrated receiver/decoder (IRD) farm shown in FIG. 1. For example, the European Free-to-Air satellite network, “Hotbird 13.0E” has 114 transponders. Some of the transponders handle private data and some handle pay-only channels. Each of the transponders may handle separate data, at separate frequencies, coding, and encryption. Each output signal is converted to a Media Transport Stream (such as MPEG) and sent into a closed high-bandwidth signal Media local area network (LAN) for access by customers.

The customer selects a program from the website which leases a TV management encoder channel from the media encoder farm, and the encoder tunes to the channel that contains the selected program. The encoder then fetches the specific data or channel stream, encodes or transcodes the data (depending on the form of the signal input and required form of the signal output) for distribution and/or for storage in a digital video recorder (DVR). Connection to a DVR allows the customer to implement pause and rewind features, as well as preserve the program for later viewing.

For many applications, some form of compression will be required before the data is distributed over the internet. Media data (picture, sound, text and subtitles) remains unchanged, but source streams with rates of 5-20 Mbps must be encoded and compressed before distribution over the Internet.

In an embodiment, the customer has an individual connection to satellite data, and the ability to select any channel available to the satellite. Private resources are leased to each customer, such as the delivery feed and the media encoder. An individual satellite can provide data content to literally an unlimited number of users. Adding additional users only requires the ability to encode a separate channel for distribution to each individual user. Therefore, 10,000 users may require 10,000 channel encoders, or at least the ability to encode 10,000 separate channels.

A current system limitation for some paid channels is the requirement for two-way communication between the satellite and receiver. Access is provided only to authorized receiver IDs. However, the current system can handle all Free-To-Air (FTA) channels.

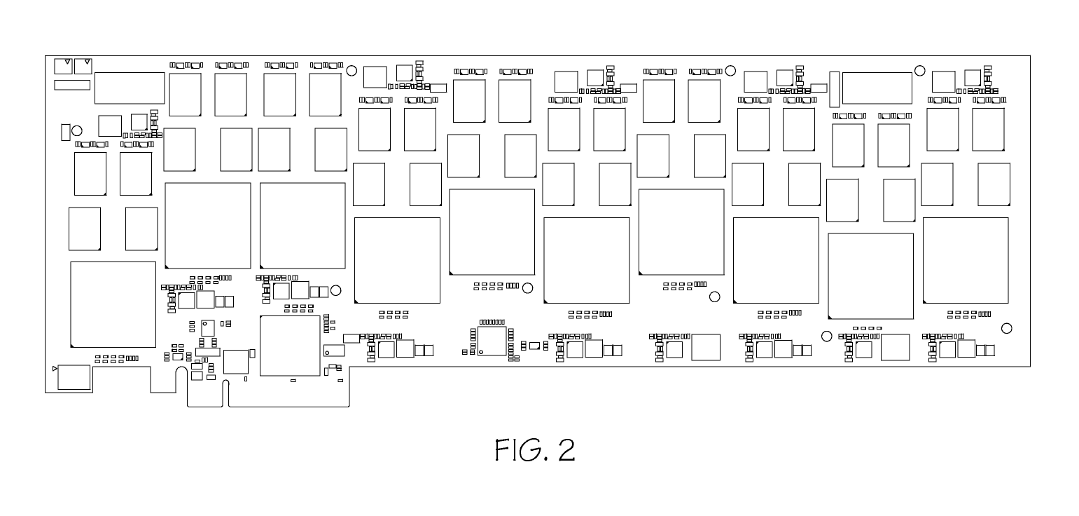

FIG. 2 depicts an example of a board with a 10-channel transcoder used to encode a satellite transmission, potentially to 10 unique subscribers. In an embodiment, the 10-channel transcoder supports 10-bit HEVC (high efficiency video encoding) content to MPEG-2 and MPEG-4, enabling highly efficient bandwidth utilization and high-density transcoding.

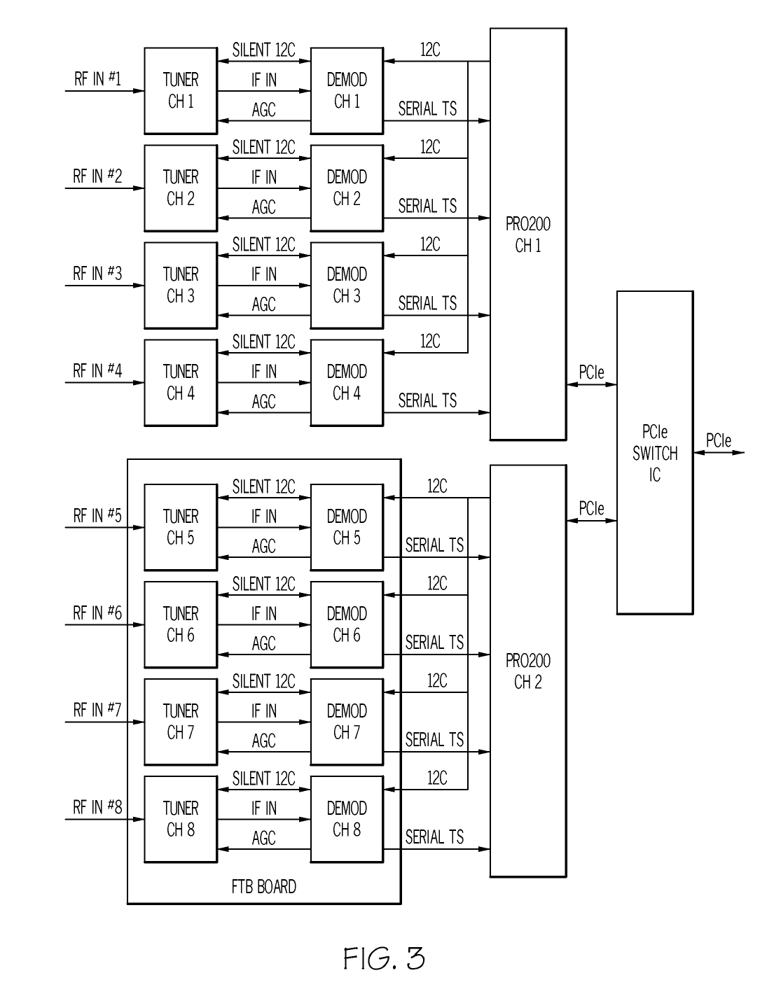

FIG. 3 depicts a block diagram of an 8-channel RF-Input to PCIe-Output board. The RF input comes to the user from the optimized antenna, through the media encoder, and the DVR server. In operation, the tuners are tuned to the desired frequency to receive the desired content. The demodulators demodulate and decode the separate transmissions. The demodulated and decoded streams are provided to the PRO200 transcoders and converted into the appropriate format using ATSC decoders. The ability to seamlessly view content on any device in real-time requires the need to transcode many video formats, thus multi-format transcoding is essential.

The transcoded streams are provided to the PCIe card and made available to the user's PC. PCIe is based on point-to-point topology, with separate serial links connecting every device to the root complex (host).

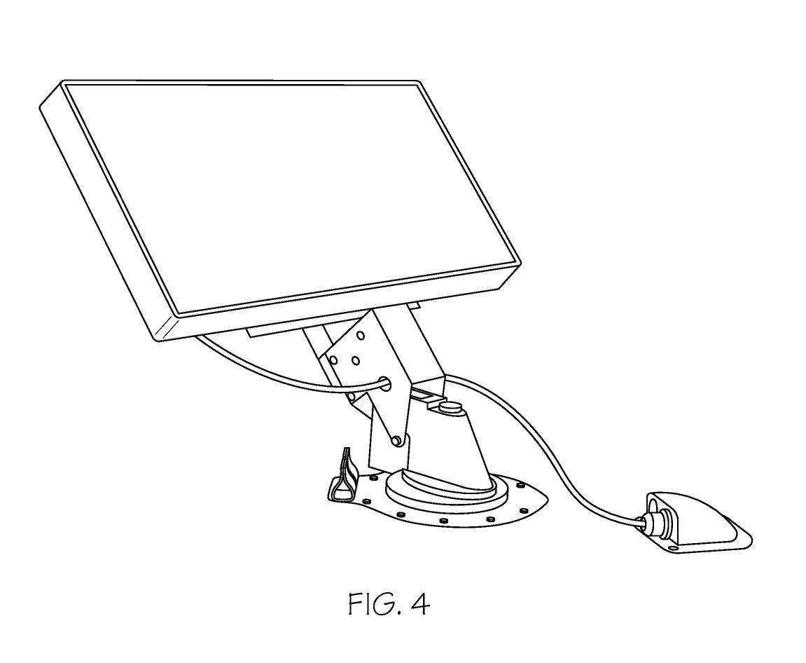

FIG. 4 depicts an example 7-8 inch flat-plate satellite downlink receiving antenna. The antenna can be steered in azimuth and elevation to optimize the signal-to-noise ratio for the received signals from the plurality of satellites.

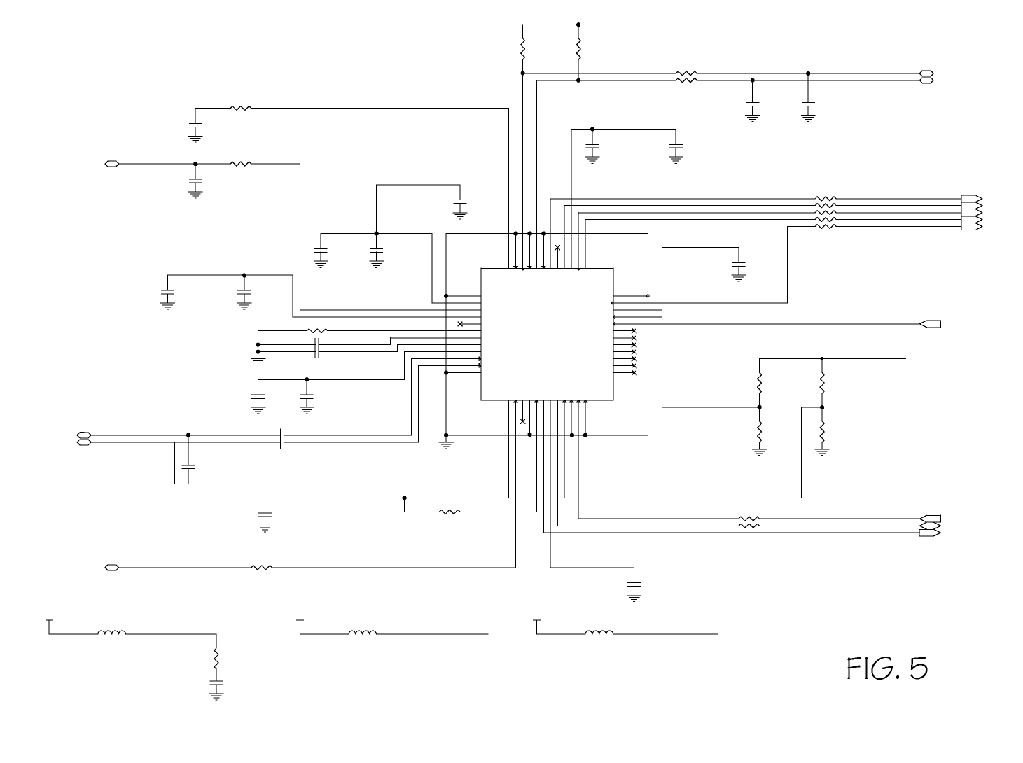

FIG. 5 depicts an example schematic of an ATSC/QAM demodulator, as shown in FIG. 3.

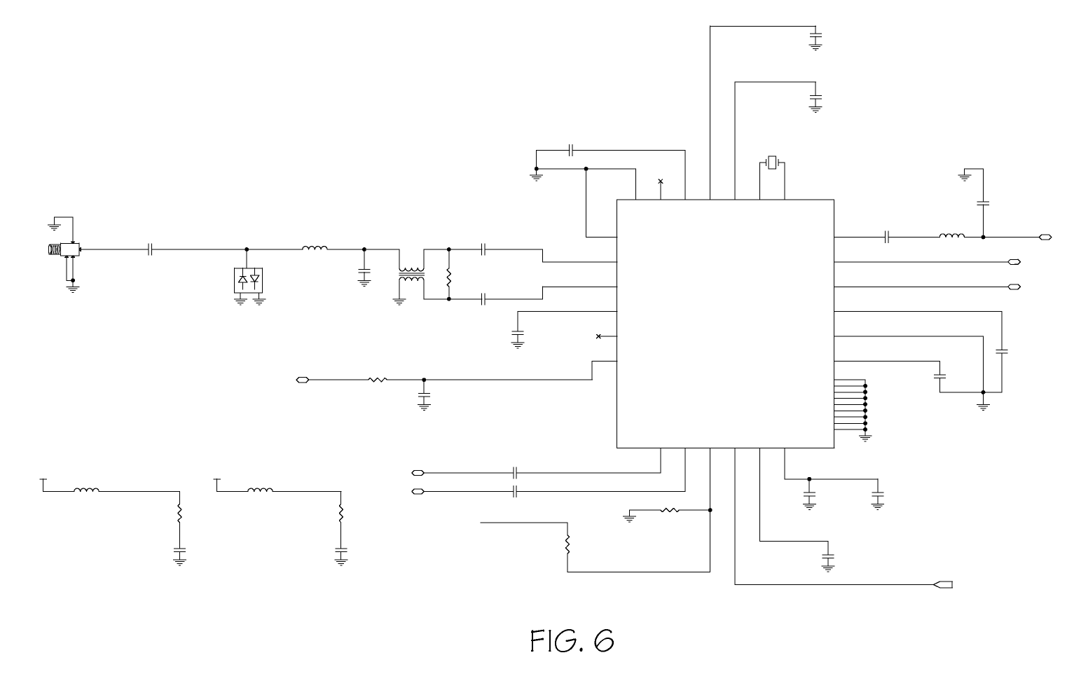

FIG. 6 depicts an example schematic of an ATSC/QAM tuner, as shown in FIG. 3.

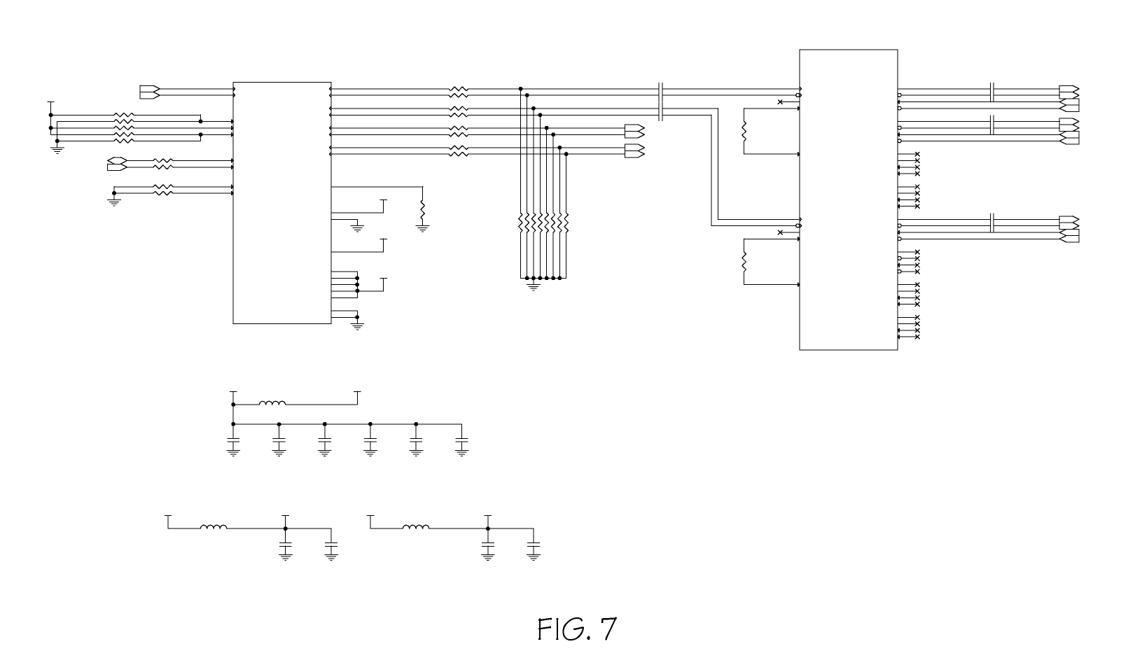

FIG. 7 depicts an example schematic of a PCIe Clock-Buffer for streaming the parallel channels to the PC. The PCIe bus link supports full-duplex communication between any two endpoints, with no inherent limitation on concurrent access across multiple endpoints.

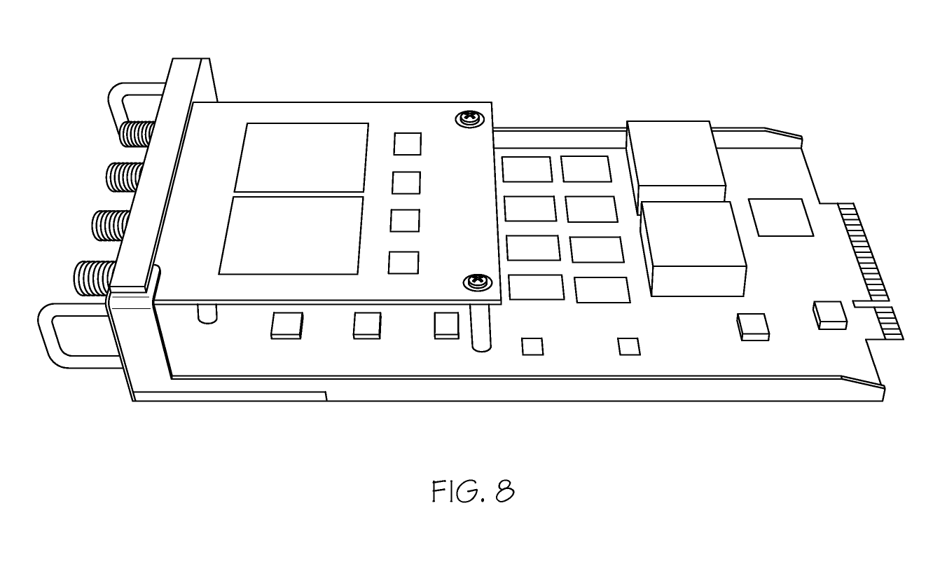

FIG. 8 is a photograph of a hardware prototype PC plug-in PCIe module.

General Definitions

“ATSC” (Advanced Television Systems Committee) tuner may refer to an ATSC receiver or HDTV tuner which is a type of television tuner that allows reception of digital television (DTV) channels transmitted by television stations in North America, parts of Central America and South Korea that use ATSC standards. Such tuners may be integrated into a television set, VCR, digital video recorder (DVR), or set-top box that provides audio/video output connectors of various types. http://en.wikipedia.org/wiki/ATSC_tuner.

“Automatically” means the use of a machine to conduct a particular action. For instance, processes by which data is extracted, organized and stored is a an automatic process and may utilize a computer network (e.g., wide area network, such as the internet, a local area network, a mobile communications network, a public service telephone network, and/or any other network and may be configured to electronically connect a user computing device (e.g., a PC) and a server computing device (e.g., cloud, mainframe, or other server device).

“Calculate” means determining or ascertaining a result or computer machine output using computer machine input.

“Communications Medium” includes both wired and wireless modes of electronic communication including but not limited to satellite, digital, analog, and other such forms of communication known in the art.

“Computer Machine” means a machine (e.g., desktop, laptop, tablet, smartphone, television, server, as well as other current or future computer machine instantiations) containing a computer processor that has been specially configured, to create a special purpose computer machine, with a set of computer executable instructions to automatically perform the set of computer executable instructions (a computer machine may also be deployed within other machines such as a magnetometer or accelerometer). References to “a first”, “one” or “at least one” computer machine are intended to encompass both autonomous systems and sub-systems as well as situations where a given functionality might be divided across multiple machines (e.g. parallel processing) for efficiency or other purposes.

“Computer Machine Input/Output” means input/output received/produced by a computer machine.

“DVR” refers to a digital video recorder.

“FTT-FTB” may refer to a fiber-optic termination box.

“Exemplary” means giving an example; serving as a non-limiting illustration or example of something.

“Computer Memory,” for at least one embodiment described herein, is non-volatile, non-transitory computer storage comprising RAM, ROM, a flash memory, a hard drive, or any device capable of storing machine readable instructions and/or data.

“Network Interface Hardware” may include any wired/wireless hardware generally known to those of skill in the art for communicating with other networks and/or devices.

“PCI Express” (Peripheral Component Interconnect Express), officially abbreviated as “PCIe”, is a high-speed serial computer expansion bus standard.

A “Processor” means any processing component configured to receive and execute instructions (such as from the data storage component and/or computer memory component) and may include a controller, an integrated circuit, a microchip, a computer, or any other computing device. References to first and second processors may reside in different specially coded computer machines or may be a single computer machine that is specially encoded with different computer executable instructions stored on the same processor. References to first and second processors within a given configuration are for purposes of convenience and not intended to be limiting as various configurations are possible and would be known to one of skill in the art.

“QAM” stands for quadrature amplitude modulation, the format by which digital cable channels are encoded and transmitted via cable television providers. QAM is used in a variety of communications systems such as dial-up modems and WiFi. In cable systems, a QAM tuner is linked to the cable in a manner that is equivalent to an ATSC tuner which is required to receive over-the-air (OTA) digital channels broadcast by local television stations when attached to an antenna. Most new HDTV digital televisions support both of these standards. QAM uses the same 6 MHz bandwidth as ATSC, using a standard known as ITU-J.8b.

A “Server” means a customized computer machine or a general purpose computer machine with the requisite hardware, software, and/or firmware. A server may include a processor, input/output hardware, network interface hardware, a data storage component (which stores data and/or metadata) and a memory component configured as volatile or non-volatile memory including RAM (e.g., SRAM, DRAM, and/or other types of random access memory), flash memory, registers, compact discs (CDs), digital versatile discs (DVD), and/or other types of storage components. A memory component may also include operating logic that, when executed, facilitates the operations described herein.

Additional Definitions

A “Satellite Dish” includes a dish-shaped type of parabolic antenna designed to receive microwaves from communications satellites, which transmit data transmissions or broadcasts, such as satellite television. (See generally, Wikipedia—Satellite Dish: https://en.wikipedia.org/wiki/Satellite_dish).

A “Multiswitch” includes a device used with a low noise blocker to distribute satellite TV signals to multiple (usually more than four) receivers from a single dish and LNB. (See generally, Wikipedia—Multiswitch: http://en.wikipedia. org/wiki/Multiswitch).

“Encoding” and “Transcoding” are sometimes used synonymously. Encoding implies taking an unencoded stream and encoding it. Transcoding takes an already encoded stream and re-formats it into a different code, or bitrate. Transcoding includes the digital-to-digital data conversion of one encoding to another, such as for movie data files or audio files. (See generally, Wikipedia—Transcoding: https://en.wikipedia.org/wiki/Transcoder).

Aspects and embodiments of the invention relate to data transmission systems in general, and more particularly to such systems for transmitting audiovisual data from a satellite to end users. Programs, films, and other content/media may be broadcast over terrestrial and satellite television networks but users may be limited in their ability to view such transmissions by the need for specific equipment (e.g., a set-top box). Audiovisual data, however, can be obtained via the Internet in a multitude of forms including, but not limited to, .avi and .wmv files.

The audiovisual files may be encrypted before transmission according to an algorithm or code specific to that user (which may be static or dynamic in nature), so that only the bona fide user who requested the audiovisual data is able to view it. Embodiments disclosed herein may permit a user to view content on a personal computer, phone, television, tablet, etc.

In aspects disclosed herein, there may be a data transmission system comprising: means for receiving one or more requests from a plurality of users via a management interface, means for receiving/obtaining a transmission of audiovisual data related to the request, data storage means for storing a set of data derived from the transmission, and means for transmitting selected data to a specific requestor associated with the request which prompted the transmission.

Embodiments disclosed herein may further comprise means for encrypting the data prior to transmission to the requestor. Components of the system may be proximate or remote to each other.

In embodiments disclosed herein, a data receiver, or a user, may access a list of programming or audiovisual data available on a channel transmitted via a satellite broadcast. The list may be accessed on a laptop, phone, or through another computer machine interface. Communication between the user and the source of the programming list may be via the Internet or other form of networked communication. From the list of available channels and/or program, the user selects at least one program or feed. A request (perhaps embodied via an HTTP request) may be submitted to a management server to direct a satellite antenna to access a transmission comprising data related to the request and download that feed to an encoding farm. An encoder may encrypt the transmission using an encryption computer machine to protect the transmission. The encryption computer machine may create an individualized encryption key or even algorithm for the user. This may be statically associated with a specific user or it may be generated on the fly or it may be assigned from a lookup table of encryption keys/algorithms at the time of request or downloading.

In embodiments disclosed herein, a subscriber may remotely tune into any satellite channel without requiring any further equipment than an Internet connection and a viewing device (e.g., a laptop, tablet, television, phone, etc.). The subscriber may choose from a selection of channels/data made available via a plurality of predetermined satellites. A tuner may be associated with each subscriber which is, in turn, connected to a satellite dish associated with content requested by the subscriber. In this way, the subscriber achieves the effect of having a home satellite tuner box in their own living room and a satellite dish on their roof without the need for this equipment or the hassle of set-up and maintenance. Embodiments disclosed herein allow a user to “tune in” remotely from anywhere in the world and have the same media delivered to them via the Internet.

Embodiments disclosed herein may assign a single satellite dish per subscriber or utilize a multi-switch to reduce the number of satellites and tuners required by a large number of simultaneous users.

In embodiments disclosed herein, a series of satellite dishes may be disposed pointing toward a plurality of satellites. A transport stream may be downlinked on request by a customer from a TV Management Server. The transport stream may be received in a multiswitch component. The transport stream may be sent to a decoder machine where it is decoded (in a similar fashion to the functionality of a set-top box in an individual residence). The decoded file(s) may be passed through a media LAN (local area network) to an encoder farm. A unique encoding of the transport stream may be made in the encoder farm. The encoded files may be stored in a DVR server where a unique temporary or permanent copy of the encoded files may be made depending on the option chosen by the user. The encoded files are unique to a specific requestor and may not be viewed by other subscribers even if another subscriber has requested the same media at the same time (that second user would receive their own unique copy of the requested content). A user may pull their encoded copy of the media from their allocated DVR space for viewing on any of a number of devices including a television, mobile device, and more.

The drawings, systems and methods described herein relate to the remote viewing of broadcast television or other media carried by signals or other data streams.

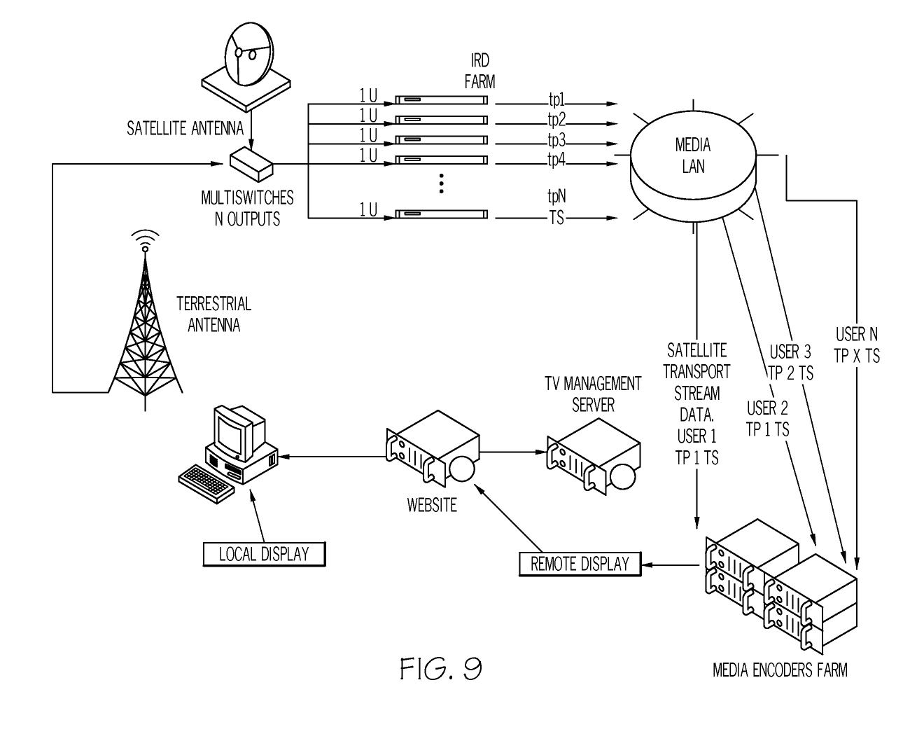

FIG. 9 shows a system that enables a local user to view TV programming that is displayed on a remote display.

Referring to FIG. 9, in embodiments disclosed herein, media signals may be received from satellites or antennas. The signals pass through an integrated receiver/decoder (IRD) farm, and are converted to Media Transport Streams (such as MPEG), and sent via a high-bandwidth signal for access by a remote device. Users may access the system through a client device (e.g., using a JAVA app encoded on a webpage via the Internet; note, however, the necessary configuration could be programmed in a number of different programming languages accessed by the user through a variety of mechanisms within the skill of the art). The client device may be a personal computer (or any IP-connected device with a display or audiovisual output mechanism—e.g., non-traditional displays such as Google Glasses).

A remote device, for example, a computer, may run audiovisual content obtained from the media encoder farm. The remote device possesses the hardware and/or software required to receive incoming streams of media data. Embodiments disclosed herein may not provide actual video output on the remote device to make the board more compact by not including display ports.

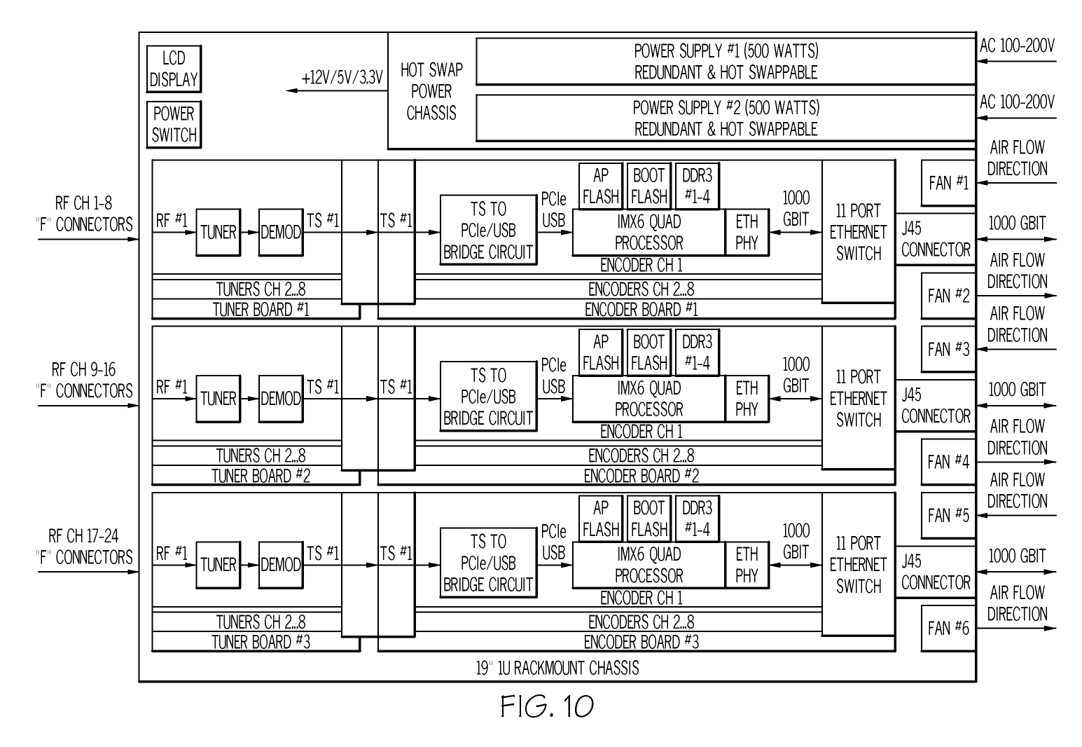

FIG. 10 shows an exemplary top-level block diagram of a remote viewing device. This example, which fits in a 1U chassis, provides 24 channels/PC operating systems. It may include three, 8-channel boards based on a quad-core, 1.2 GHz processor for each channel. Each channel decodes a transport stream (TS) input from the tuner board. The decoded stream is run on the remote device through its audio-visual software/hardware. The tuner boards may comprise a modular design and can handle DVB-T, DVB-S or ATSC, merely by switching tuner boards; however, a main encoder board could also be configured for different transport streams. Embodiments of a remote viewing device may also include redundant hot swappable power supplies.

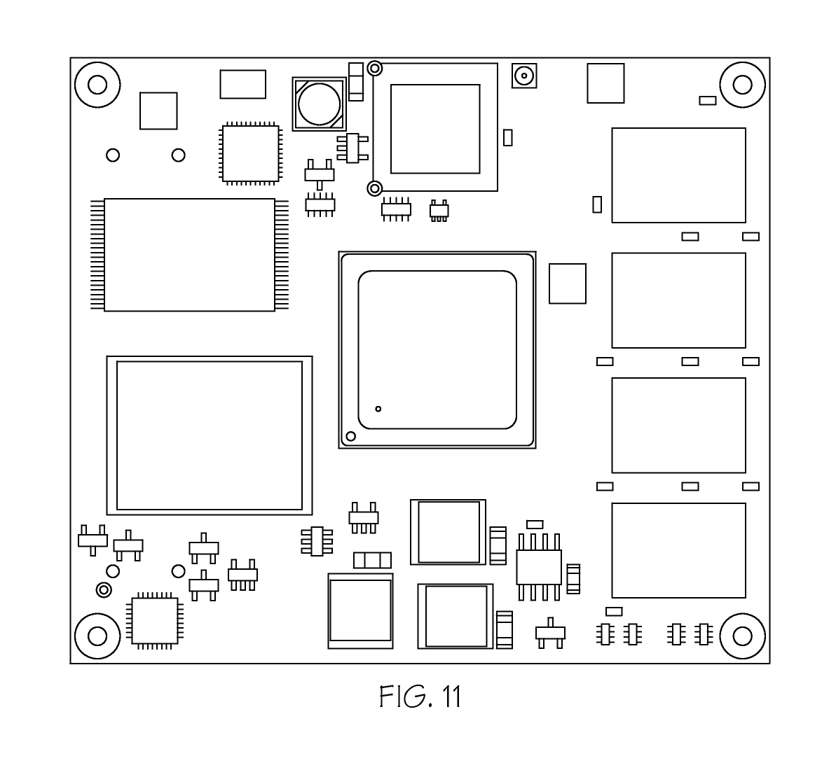

FIG. 11 depicts a hardware example of the circuit board for the remote device.

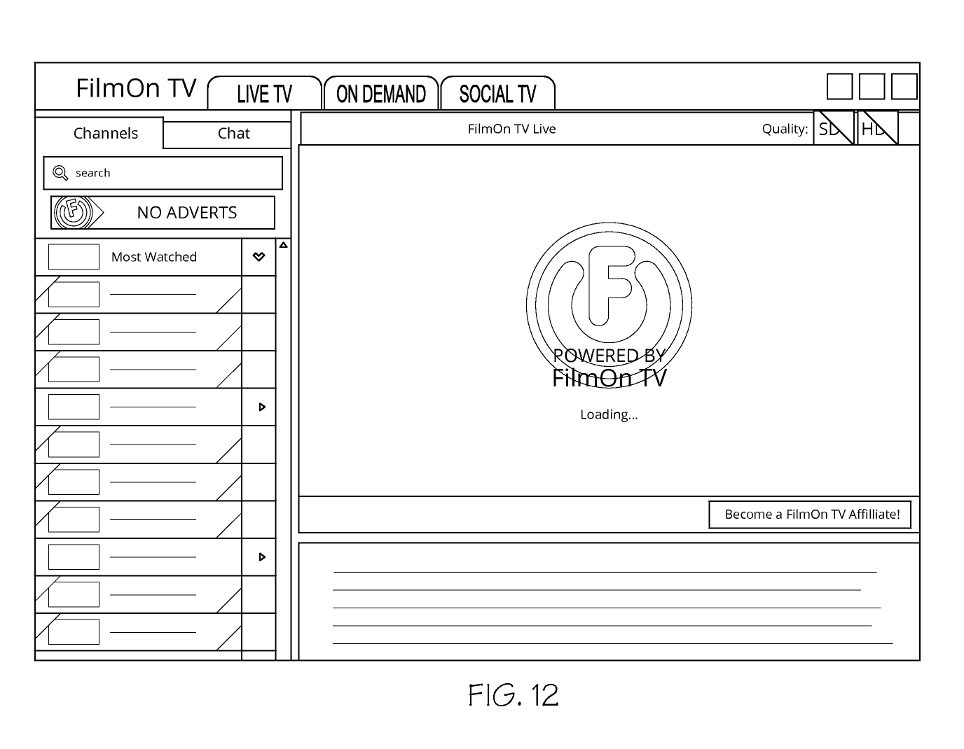

FIGS. 12-16 are screen shots that graphically depict the steps for remote viewing.

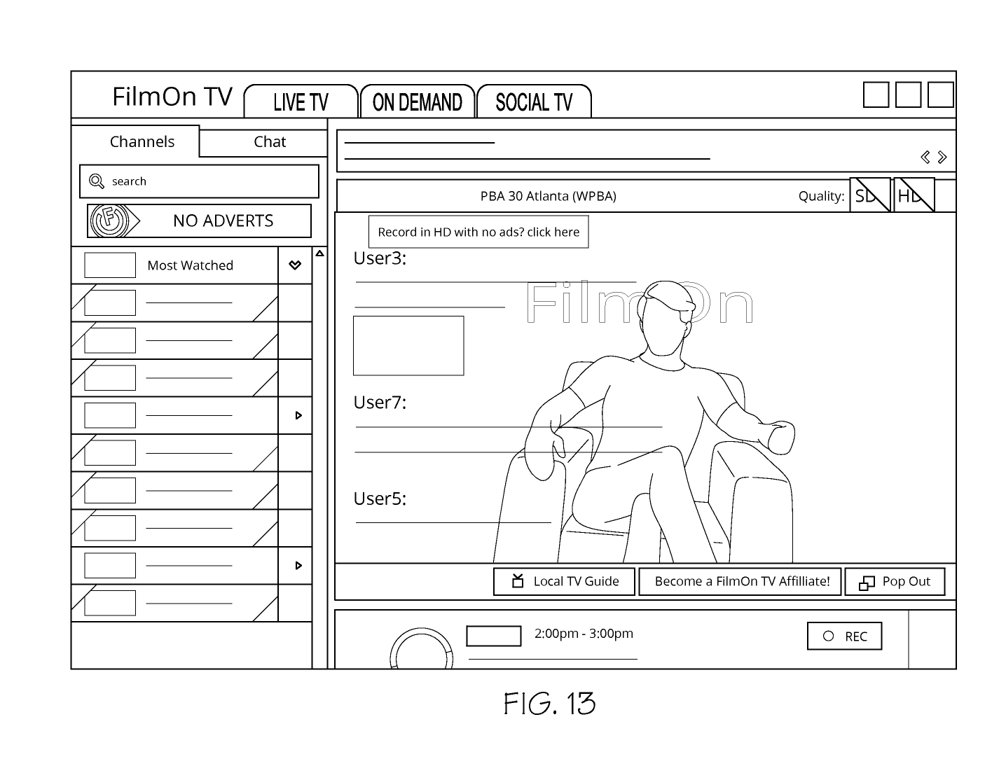

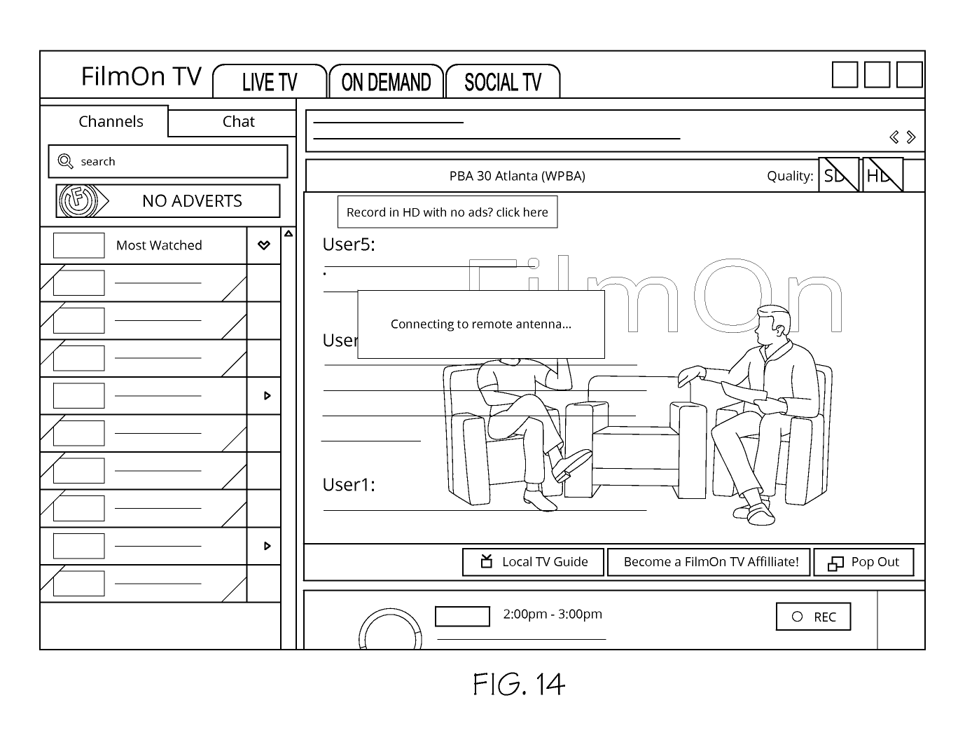

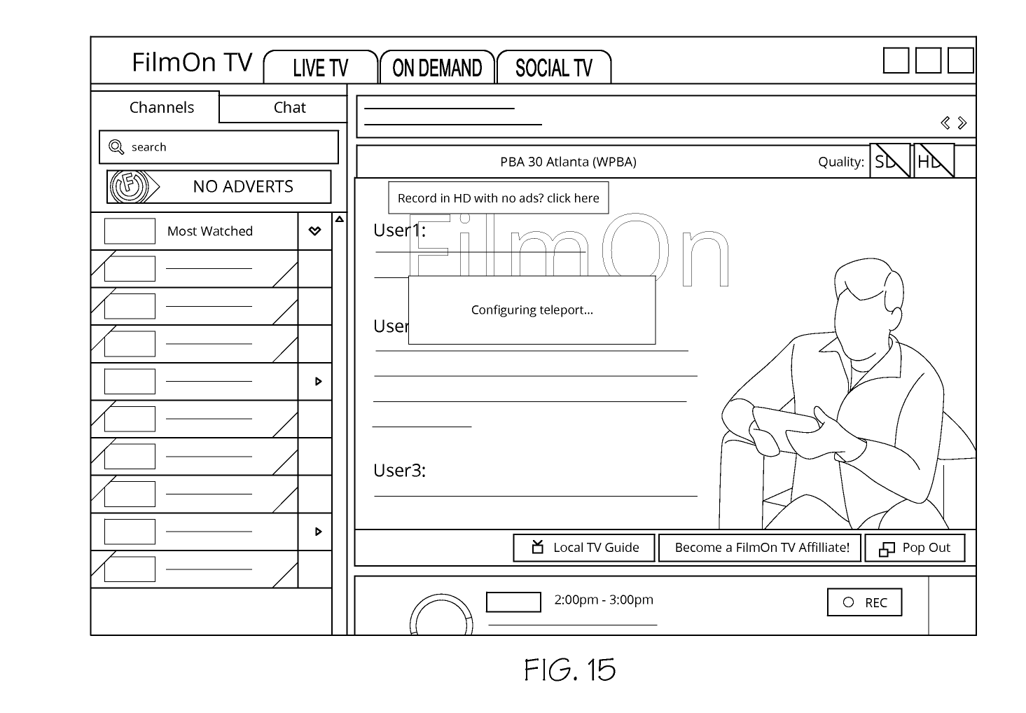

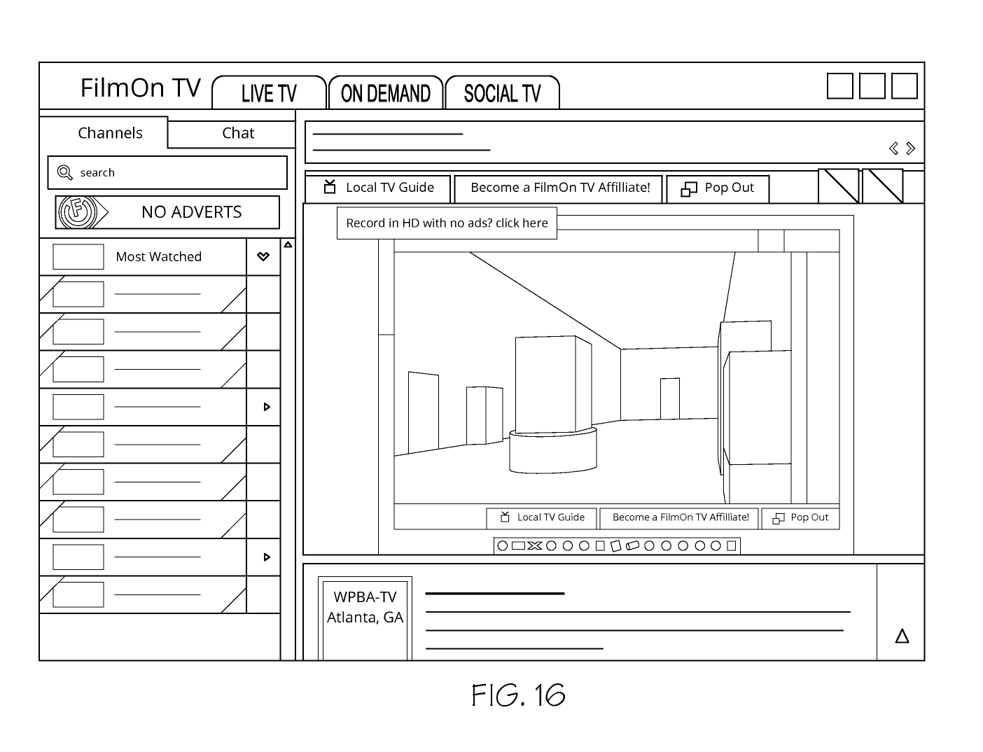

FIG. 12 shows user's display at the local player. The user connects to the website to begin the process. In FIG. 13, the available sites for remote TV viewing are listed on the left hand of the display. The user may input, for example, a city in the searching tool to surface channels available from that region. FIG. 14 shows that “Atlanta” has been selected. The display then lists the available channels in Atlanta. A user may select “PBA 30 Atlanta (WPBA)” for shared display. FIG. 15 shows the local viewer being configured to view the desired channel. FIG. 16. shows the completed process, with WPBA Atlanta shared to the user's local player while actual playback occurs on the remote device.

Each of the servers, systems, and/or computing devices described herein may include one or more processors; one or more memory modules communicatively coupled to the one or more processors; and machine readable instructions stored in the one or more memory modules that cause the system to perform the functionality described herein. Each of the servers, systems, and/or computing devices described herein may be communicatively coupled to another server, system, and/or computing device, and/or may be communicatively coupled to one or more satellite antennas.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system comprising:
a satellite antenna;
one or more processors communicatively coupled to the satellite antenna;
one or more memory modules communicatively coupled to the one or more processors; and
machine readable instructions stored in the one or more memory modules that cause the system to perform at least the following when executed by the one or more processors:
receive a request for selected data content;
in response to receiving the request for the selected data content, automatically determine an azimuth and elevation of the satellite antenna to optimize a signal-to-noise ratio to receive a signal comprising the selected data content from a satellite; and
after determining the azimuth and elevation, steering the satellite antenna to the azimuth and elevation such that the satellite antenna receives the signal comprising the selected data content from the satellite.

2. The system of claim 1, further comprising an integrated receiver/decoder farm communicatively coupled to the satellite antenna, wherein the integrated receiver/decoder farm receiver receives the signal comprising the selected data content from the satellite antenna, decodes the signal, and outputs a media transport stream comprising the decoded signal.

3. The system of claim 2, further comprising a media encoder that receives the media transport stream from the integrated receiver/decoder farm, and encodes or transcodes the media transport stream into processed data.

4. The system of claim 3, further comprising a data storage system communicatively coupled to the media encoder, wherein the data storage system receives the processed and stores the processed data.

5. The system of claim 3, further comprising a streaming server, wherein the streaming server transmits the processed data to a remote user computing device via the Internet.

6. The system of claim 1, further comprising an antenna controller, wherein the antennal controller steers the satellite antenna to the azimuth and elevation such that the satellite antenna receives the signal comprising the selected data content from the satellite.

7. The system of claim 1, wherein the satellite antenna is included within an array of satellite antennas.

8. The system of claim 1, further comprising an application server, wherein the machine readable instructions stored in the one or more memory modules further cause the system to perform at least the following when executed by the one or more processors:
present the user with a list of available data content accessible via the satellite antenna; and
receive a request for selected data content in response to a user selection of an item of the list.

9. The system of claim 1, wherein the machine readable instructions stored in the one or more memory modules further cause the system to perform at least the following when executed by the one or more processors:
provide an application programming interface to enable users to design a custom label to access data content.

10. The system of claim 1, wherein the machine readable instructions stored in the one or more memory modules further cause the system to perform at least the following when executed by the one or more processors:
in response to receiving the request for the selected data content, assigning the satellite antenna to receive the signal comprising the selected data content.

11. The system of claim 10, wherein the machine readable instructions stored in the one or more memory modules further cause the system to perform at least the following when executed by the one or more processors:
after receiving the selected data content, making the assigned satellite antenna available to other users.

12. A system comprising:
a satellite antenna that outputs a downlink signal;
a tv management server, wherein the tv management server presents the user with a list of available data content accessible via the satellite antenna, and receives a request for selected data content in response to a user selection of an item of the list;
an antenna controller, wherein in response to receiving the request for the selected data content, the antenna controller:
automatically determines an azimuth and elevation of the satellite antenna to optimize a signal-to-noise ratio to receive the downlink signal from the satellite; and
after determining the azimuth and elevation, steering the satellite antenna to the azimuth and elevation such that the satellite antenna receives the downlink signal;
an integrated receiver/decoder farm that receives the downlink signal from the satellite antenna, decodes the downlink signal, and outputs a media transport stream;
a media encoder that receives the media transport stream and encodes or transcodes the media transport stream into processed data;
a streaming server, wherein the streaming server transmits the processed data to a remote user computing device via the Internet; and
a data storage system communicatively coupled to the satellite antenna, wherein the data storage system receives the selected data content and stores the selected data content.

13. The system of claim 12, wherein at least one of the media encoder and the streaming server compresses the processed data prior to transmitting the processed data to the remote user computing device.

14. The system of claim 12, wherein the system encrypts the processed data prior to transmission.

15. The system of claim 12, further comprising a multiswitch that receives the downlink signal and separates the downlink signal into a plurality of output signals provided to the integrated receiver/decoder farm.

16. The system of claim 12, further comprising an antenna optimization and control system communicatively coupled to the tv management server, wherein:
the tv management server receives a request to schedule a recording of content;
the tv management server transmits a message to the satellite antenna optimization and control system in response to receiving the request to schedule; and
the antenna optimization and control system reserves antenna and encoding resources for the scheduled recording of content.

17. The system of claim 12, further comprising an antenna optimization and control system communicatively coupled to the tv management server, wherein:
the tv management server receives a request to view live broadcast content;
the tv management server transmits a message to the satellite antenna optimization and control system in response to receiving the request to view the live broadcast content; and
the antenna optimization and control system identifies antenna resources for immediate use to view the live broadcast content.

18. The system of claim 12, further comprising a remote display and a local display communicatively coupled to the remote display, wherein the remote display displays the processed data from the media encoder and the local display displays the content displayed on the remote display.

19. The system of claim 12, wherein the machine readable instructions stored in the one or more memory modules further cause the system to perform at least the following when executed by the one or more processors:
provide an application programming interface to enable users to design a custom label to access data content.

20. A system comprising:
a satellite antenna that outputs a downlink signal;
a tv management server, wherein the tv management server presents the user with a list of available data content accessible via the satellite antenna, and receives a request for selected data content in response to a user selection of an item of the list;
an antenna controller, wherein in response to receiving the request for the selected data content, the antenna controller:
automatically determines an azimuth and elevation to optimize a signal-to-noise ratio to receive the downlink signal from a satellite; and
after determining the azimuth and elevation, steers the satellite antenna to the azimuth and elevation such that the satellite antenna receives the downlink signal from the satellite;
a multiswitch that receives the downlink signal and separates the downlink signal into a plurality of output signals;
an integrated receiver/decoder farm that receives the output signals from the multiswitch, decodes the output signals from the multiswitch, and outputs a media transport stream;
a media encoder that receives the media transport stream and encodes or transcodes the media transport stream into processed data;
a streaming server that transmits the processed data to a remote user computing device via the Internet; and
a data storage system communicatively coupled to the satellite antenna, wherein the data storage system receives the selected data content and stores the selected data content.
